(19) United States
(12) Patent Application Publication
(10) Pub. No.: US 2025/0219678 A1
(43) Pub. Date: Jul. 3, 2025

(54) WIRELESS SAMPLER TRANSMITTER

(71) Applicant: Wiliot, Ltd., Caesarea (IL)

(72) Inventors: Alon YEHEZKELY, Haifa (IL); Eylon GERSTEN, Even Yehuda (IL)

(73) Assignee: Wiliot, Ltd., Caesarea (IL)

(21) Appl. No.: 19/002,312

(22) Filed: Dec. 26, 2024

Related U.S. Application Data
(60) Provisional application No. 63/615,138, filed on Dec. 27, 2023.

(51) Int. Cl. H04B 5/48; H02J 50/00; H04B 5/73; H04B 5/79

(52) U.S. Cl. CPC H04B 5/48; H02J 50/001; H04B 5/73; H04B 5/79

(57) ABSTRACT

A device for sampling one or more indicators is provided. The device includes a system on a chip (SoC); an antenna for harvesting electromagnetic energy, wherein the energy is managed by the SoC and stored in an accumulator; and an electrode positioned adjacent to the one or more indicators, wherein the SoC utilizes the electrode to sample information from the one or more indicators and transmit the information by the antenna.

### CROSS-REFERENCE TO RELATED APPLICATIONS

This application claims priority to U.S. Provisional Application No. 63/615,138,filed on Dec. 27, 2023. The contents of which are incorporated by reference.

### TECHNICAL FIELD

The present disclosed subject matter relates to wireless sensors. More particularly, the present disclosed subject matter relates to energy-harvesting-based wireless samplers and transmitters.

### BACKGROUND

Monitoring temperature changes in the distribution process is crucial to ensure the safety and efficacy of temperature-sensitive products, such as drugs, vaccines, and food items. Time-temperature indicators are commonly used for this purpose.

Traditional time-temperature indicators, like digital thermometers, are costly, limiting their use to designated areas such as refrigerated vehicles or warehouses.

Modern commercially available time-temperature indicators are labels for attachment to sensitive product packaging. These labels display the accumulated time-temperature history of a product. The basic types of time-temperature indicators include partial history indicators, which show whether a product has experienced temperature deviations during a specific phase of its lifecycle; full history indicators, which reveal whether a product has encountered temperature deviations throughout its entire lifecycle; and critical temperature indicators, which monitor a threshold temperature, above which irreversible product damage may occur.

Full history indicators are two-dimensional, using two non-interfering parameters, typically color and length, to indicate both temperature and time, allowing them to track fluctuating temperature conditions over 30 days or more.

However, there is a drawback. These low-cost disposable indicators enable temperature recording over time for individual products, but they present a labor-intensive challenge in logging these recordings.

Therefore, the objective of the present disclosure is to provide a solution that addresses the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, the device may include a system on a chip (SoC). The device may also include an antenna for harvesting electromagnetic energy, where the energy is managed by the SoC and stored in an accumulator. The device may furthermore include an electrode positioned adjacent to the one or more indicators, where the SoC utilizes the electrode to sample information from the one or more indicators and transmit the information by the antenna. Other embodiments of this aspect include corresponding computer systems, apparatus, and computer programs recorded on one or more computer storage devices, each configured to perform the actions of the methods.

Implementations may include one or more of the following features. The device where the antenna is made of at least one conductive pattern printed onto a thin flexible insulating substrate. The device where the antenna is designed to receive and transmit radio-frequency (RF) signals in a short-range communication protocol. The device where the antenna is adapted to receive RF signals in a plurality of RF bands for harvesting electromagnetic energy. The device where the accumulator may include one or more of an on-die capacitor, at least one external capacitor, and at least one rechargeable battery. Device where the SoC may include: a harvester; a controller; a transceiver; and a probe. The device where the controller is partitioned into multiple power domains each having a set of gates powered by a common power supply, where only one power domain is turned on during execution. The device where the controller is configured to manage power levels of the harvester and generate and prepare data packets for transmission. The device where the controller utilizes the transceiver for communicating BLE protocols via the antenna. The device where the harvester is configured to regulate and provide power into multiple DC voltage levels for the operation of SoC and its subcomponents. The device where the probe may include circuitry configured to measure and digitize electrical properties sensed by the electrode. The device where the electrical properties are at least one of the following: voltage; current; resistance; capacitance; induction; and light transparency. The device where the electrode may include one or more of a photovoltaic sensor, a dielectric sensor, an inductor, and a penetrating conductor. The device where the electrode is attached to at least one indicator is used for recording temperature or humidity over a predetermined time and displaying visual results. The device where a controller compiles transmission representing temperature and/or humidity measurements over time and transmits the information to a server. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features and advantages of the disclosure will be apparent from the following detailed description taken in conjunction with the accompanying drawings.

In the drawings:

FIG. 1 shows a block diagram of a wireless sampler transmitter (WST), In some exemplary embodiments of the disclosed subject matter;

FIG. 2 shows a circuit layout of the WST, in some exemplary embodiments of the disclosed embodiments; and

FIGS. 3A, 3B, and 3C depict diagrams, in accordance with some exemplary embodiments of the disclosed embodiments.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be plural and vice versa with no loss of generality. In the drawings, like numerals refer to like parts through several views.

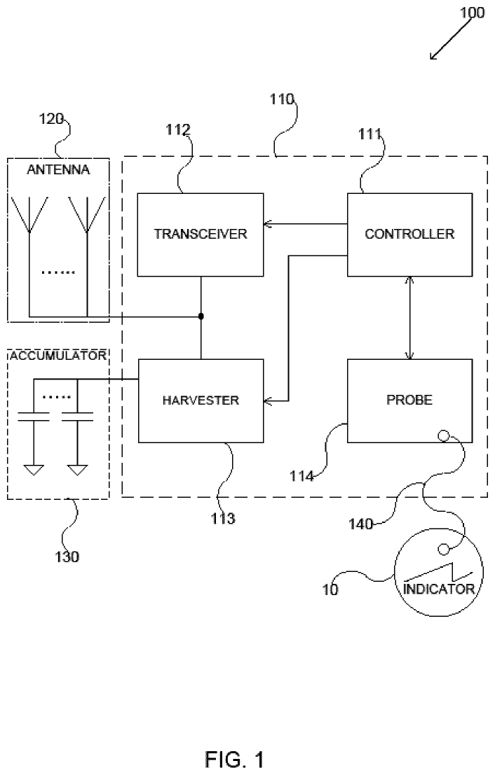

FIG. 1 shows a block diagram of a wireless-sampler-transmitter (WST) 100 designed according to some exemplary embodiments of the disclosed subject matter; WST 100 may be an Internet of Things (IoT) device coupled with an indicator 10.

Indicator 10 may be a time-temperature indicator, a time-humidity indicator, or the like that is capable of recording a property of physical, biological, or chemical nature, such as temperature, humidity, acidity, viral load over a predetermined time and displaying visual results. Additionally, or alternatively, indicator 10 may be a non-time-related indicator. Typically, indicator 10 is a self-adhesive strip where values, such as temperature or humidity, are represented by different colors along the length of the strip, representing the time domain.

In some exemplary embodiments, WST 100 is designed to measure electrical properties, such as resistance, capacitance, induction, transparency, or the like, which are derived from the color and/or transparency to light of indicator 10 over time. It should be noted that, apart from direct light quality measurements, the electrical properties are measured through changes in a material's electrical characteristics resulting from the mechanisms that alter its color.

In some exemplary embodiments, WST 100 may include a system on a chip (SoC) 110, an antenna 120, an accumulator 130, and at least one electrode 140, all connected to indicator 10.

Antenna 120 includes at least one conductive pattern made of aluminum, copper, silver, and the like, or any combination thereof. Antenna 120 may be printed or etched onto a thin flexible insulating substrate (to be described in detail further below).

In some exemplary embodiments, antenna 120 is primarily designed to receive and/or transmit radio-frequency (RF) signals in a range of 2.4 to 2.5 gigahertz (GHz), i.e., Bluetooth Low Energy (BLE) communication. Additionally, or alternatively, antenna 120 may be adapted to receive RF signals in a plurality of RF bands in addition to the BLE range, used for harvesting electromagnetic energy, or any short range communication protocols.

Accumulator 130 may be used to store electrical energy for the operation of WST 100. In some exemplary embodiments, accumulator 130 may be an on-die capacitor, i.e., an integral part of SoC 110, and/or at least one external capacitor. Additionally, or alternatively, accumulator 130 may include at least one chargeable battery. It should be noted that capacitors store electrical energy in the form of electrical charge accumulated on their plates. When a capacitor is connected to a power source, it accumulates energy that can be released when the capacitor is disconnected from the charging source.

In some exemplary embodiments, the power source used to charge the capacitors is supplied by harvester 113, utilized to harvest electromagnetic energy received by antenna 120.

SoC 110 may include a controller 111, a transceiver 112, a harvester 113, and a probe 114. SoC 110 can be implemented as firmware written for or ported to a specific processor, such as a digital signal processor (DSP), or an application-specific integrated circuit (ASIC). In some exemplary embodiments, controller 111 may be a processing unit (CPU) or a microprocessor, utilized to perform computations required by SoC 110 or any of its subcomponents.

In some exemplary embodiments, controller 111 includes several execution functions realized as analog circuits, digital circuits, or both. Controller 111 incorporates memory (not shown) configured to retain data and program instructions to independently conduct processes. In some exemplary embodiments, controller 111 is partitioned into multiple power domains. Each power domain is a collection of gates powered by the same power and ground supply. To reduce power consumption, only one power domain is turned on during execution. Controller 111 can perform functions such as memory read/write, interfacing with input-output components, executing logic operations, tracking the power level of harvester 113, generating and preparing data packets for transmission, cyclic redundancy check (CRC) code generation, packet whitening, encrypting/decrypting and authenticating packets, converting data from parallel to serial, and staging the packet bits to the analog transmitter path for transmission.

In some exemplary embodiments, controller 111 utilizes transceiver 112 for performing various functions, allowing communication using a low-power communication protocol. Examples of such a protocol include but are not limited to, Bluetooth®, LoRa, Wi-Fi®, DECT®, Zigbee®, Z-Wave, EnOcean, cellular communication ranging from 0.5 to 3.5 GHZ, and the like. In a preferred embodiment, transceiver 112 operates using a BLE communication protocol.

In some exemplary embodiments, transceiver 112 includes an oscillator calibration circuit having at least one frequency locking circuit (FLC) adapted to use an over-the-air reference signal. It should be noted that the calibration is performed before a data transmission session and remains free-running during the data transmission session. The FLC can be realized using a frequency locked loop (FLL), a phase-locked loop (PLL), and a delay-locked loop (DLL).

An implementation example of such an oscillator calibration circuit is discussed in U.S. Pat. No. 10,886,929, assigned to the common assignee Yehezkely, and incorporated herein by reference.

Harvester 113 is configured to provide multiple DC voltage levels for the operation of SoC 110 while maintaining a low-loading DC dissipation value. In some exemplary embodiments, harvester 113 may include a Dickson voltage multiplier (not shown) coupled to the antenna 120 or a cross-coupled differential-drive rectifier.

In some exemplary embodiments, the harvested energy may be stored in accumulator 130 by harvester 113, which is also configured to regulate the power into multiple DC voltage levels for the operation of SoC 110 and its subcomponents. Due to the limited capacitance of accumulator 130, power consumption should be carefully managed. This management is conducted to prevent the depletion of accumulator 130, thereby avoiding a reset of controller 111.

In another embodiment, harvester 113 may be further configured to provide multi-level voltage indications to controller 111, enabling controller 111 to determine the state of a voltage supply at any given time when accumulator 130 is charging or discharging. For this purpose, harvester 113 utilizes detection circuitry (not shown) controlled by controller 111. In some exemplary embodiments, this detection circuitry includes different voltage reference threshold detectors, with only a subset of such detectors active at a given time to perform the detection.

It should be noted that indicator 10 records time-temperature and time-humidity data, as well as non-time-related threshold crossing data such as temperature, humidity, and the like, or any combination thereof. Additionally, it displays this data visually using color coding. WST 100 is designed to measure electrical properties derived from the color and/or transparency changes in indicator 10 over time. In some exemplary embodiments, these electrical properties can include but are not limited to, resistance, capacitance, inductance, and transparency.

Probe 114 may include one or more analog and digital circuitry configured to measure and digitize analog signals that represent electrical properties sensed by electrode 140. In some exemplary embodiments, probe 114 measures analog data, such as voltage or current, and converts them into digital values. The digital representation of electrical properties sensed by electrode 140 is then acquired by controller 111 which is configured to process, retain, and transmit the electrical properties' information to a log server. It should be noted that electrode 140 and probe 114 function as an integral part that can be referred to as probe-electrode.

It should be appreciated that controller 111 utilizes probe 114 to deduce temperature and/or humidity measurements over time, using electrode 140 as a sensor coupled with indicator 10. In some exemplary embodiments, electrode 140 may be used to capture the changes in voltage, capacitance, inductance, and resistance resulting from the indicator 10 changes.

In some exemplary embodiments, probe 114 analog and digital circuitry may be comprised of signal conditioning circuitry, such as operational amplifiers, filters, voltage regulators, analog-to-digital converter (ADC), and the like.

In some exemplary embodiments, controller 111 compiles measurement information obtained from probe 114 into BLE protocols, a 3GPP standard and WiFi (IEEE 802.11bp), and any combination thereof, or the like. Additionally, or alternatively, controller 111 utilizes transceiver 112 and antenna 120 for communicating the information to a network element (not shown) such as a router, a switch, a gateway, or any communication device that supports BLE protocol communication. In some exemplary embodiments, the network elements are utilized as repeaters for communicating the information to a log server that retains logs of information from a plurality of WST 100.

It should be appreciated that the primary objective of indicator 10, hosted by an energy harvesting device such as WST 100 of the present disclosure, is to maintain its operation even in situations where there is insufficient operational energy.

For example, a temperature sensor, i.e., indicator 10, continues to record the temperature in the absence of adequate energy to measure and transmit data.

Furthermore, even if sufficient energy is present, there may not be a network element in the vicinity of WST 100, thereby preventing the uploading of data to the log server. Storing data on the WST 100 itself could require energy and storage memory, incurring additional costs in terms of space and potential leakage current.

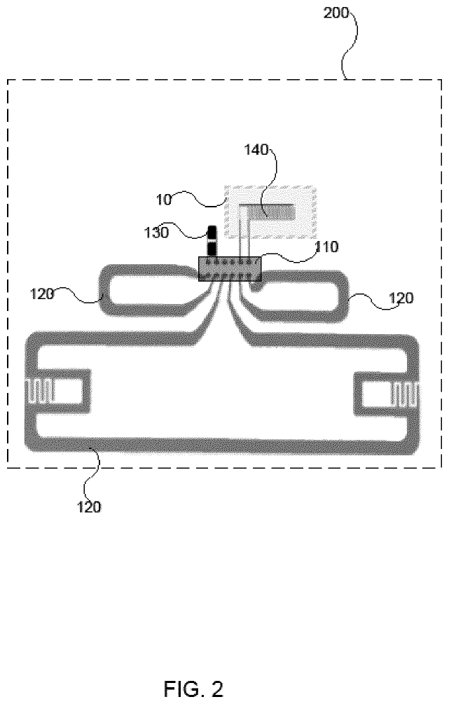

FIG. 2 shows the layout of a WST 100 IoT device. In some exemplary embodiments, a substrate 200 is a thin flexible strip that is contiguous to indicator 10 and all the components of WST 100, i.e., SoC 110, antenna 120, accumulator 130, and electrode 140.

Substrate 200 may be made of dielectric materials, such as polyimide, polyethylene terephthalate, any type of polymer, flexible glass, and the like, or any combination thereof. In some exemplary embodiments, one side of the substrate 200 may include self-adhesive material that enables securing the WST 100 to the surface of a product packaging.

Electrical traces, embedded onto substrate 200, are formed in patterns that make up at least one antenna 120, at least one electrode 140, and interconnecting them to components of WST 100.

In some exemplary embodiments, the forming of the electrical traces may be performed by utilizing various techniques like conductive ink printing, etching, or etching on a substrate. The electrical traces are realized by conductive metals, such as copper, aluminum, and the like, or any combination thereof, which are embedded onto substrate 200. In some exemplary embodiments, indicator 10 may be bonded to WST 100 on one side, i.e., either the component side or the adhesive side, of substrate 200 in a way that overlaps electrode 140.

It should be appreciated that electrode 140 is connected to SoC 110 and is utilized by probe 114 for sensing at least one physical property, such as resistance, capacitance, induction, transparency, or the like.

In one exemplary embodiment, electrode 140 may be a photovoltaic sensor or the like for sensing the transparency of indicator 10. Additionally, or alternatively, probe 114 may measure the voltage at electrode 140, by a high input-impedance amplifier.

In another exemplary embodiment, electrode 140 may be a dielectric sensor or the like for sensing the capacitance of indicator 10. Additionally, or alternatively, probe 114 may estimate capacitance change by its impact on a circuit's time constant, or by estimation of the charge level of the capacitor.

In yet another exemplary embodiment, electrode 140 may be an inductor or the like for sensing induction of indicator 10. Additionally, or alternatively, probe 114 may be performed by the impact of the inductor on a circuit's (e.g., oscillator) time constant.

In yet another exemplary embodiment, electrode 140 may be at least one penetrating conductor for sensing the resistance of indicator 10. Additionally, or alternatively, probe 114 may be performed by using the impact of the resistor on a circuit's (e.g., oscillator) time constant, or via the voltage on the resistor electrodes in response to an expected current that is applied to it.

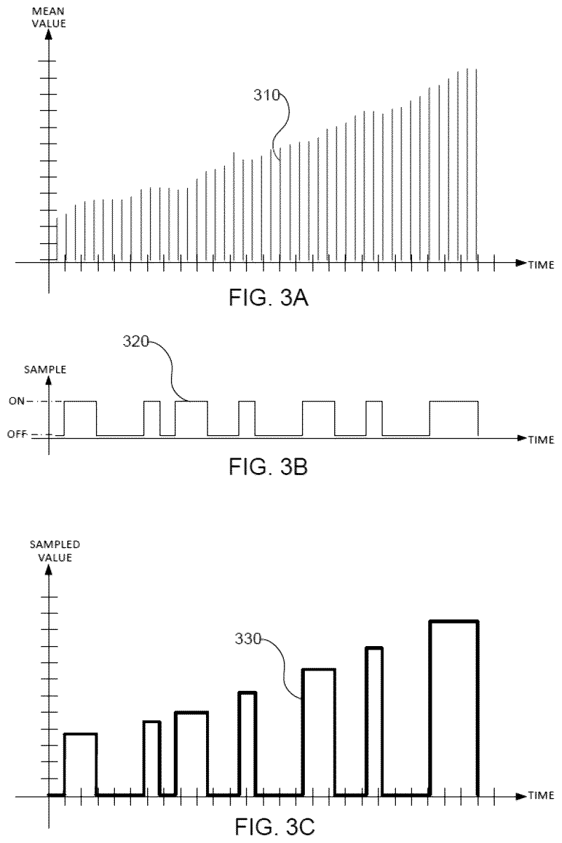

FIG. 3A is a diagram example depicting graph 310 representing either temperature or humidity to which indicator 10 is exposed over its preset time duration.

In some exemplary embodiments, a mean value (y-axis) represents temperature values or humidity values, whereas a time domain (x-axis) may be in scales of hours, days, and weeks.

While various commercially available indicators come in different forms and designs, for the sake of simplifying the description in this disclosure, cumulative graph 310 schematically represents the behavior of two-dimensional indicators used for indicating temperature and humidity through color codes over time, with the length of the indicator representing time.

FIG. 3B depicts an example of a sampling timing diagram (sampler 320). Sampler 320 can be visualized as a clock that samples Indicator 10. In some exemplary embodiments, controller 111 may trigger probe 114 to utilize its electrode 140 for measuring the electrical properties of indicator 10. It is important to note that the duration of each sampling clock, i.e., sampler 320 being in the “on” state, is determined by controller 111 and is practically derived from the power availability to SoC 110.

FIG. 3C is an example diagram depicting graph 330. In some exemplary embodiments, graph 330 represents sampled values, such as temperature and humidity, by the timing of sampler 320. In a sense, this can be viewed as the outcome of an observable period, I.e., where there is sufficient energy to measure and transmit. In some exemplary embodiments, probe 114 digitizes the sampled values, which will subsequently be retained and transmitted by SoC 110. It should be noted that the sampled values (see graph 330), as depicted in FIG. 3C, are not flat and may vary within the sampling period. It should be noted that, while SoC 110 is not powered during temperature changes, the temperature and humidity data are recorded on indicator 10. This data will be measured, processed, and transmitted during a subsequent power cycle.

The various embodiments disclosed herein can be implemented as hardware, firmware, software, or any combination thereof. Moreover, the software is preferably implemented as an application program tangibly embodied on a program storage unit or computer-readable medium consisting of parts, or certain devices and/or a combination of devices. The application program may be uploaded to, and executed by, a machine comprising any suitable architecture. Preferably, the machine is implemented on a computer platform having hardware such as one or more central processing units (“CPUs”), memory, and input/output interfaces. The computer platform may also include an operating system and microinstruction code. The various processes and functions described herein may be either part of the microinstruction code or part of the application program or any combination thereof, which may be executed by a CPU, whether or not such a computer or processor is explicitly shown. In addition, various other peripheral units may be connected to the computer platform, such as an additional data storage unit and a printing unit. Furthermore, a non-transitory computer-readable medium is any computer-readable medium except for a transitory propagating signal.

All examples and conditional language recited herein are intended for pedagogical purposes to aid the reader in understanding the principles of the disclosed embodiment and the concepts contributed by the inventor to further the art and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to the first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A device for sampling one or more indicators, the device comprising:
a system on a chip (SoC);
an antenna for harvesting electromagnetic energy, wherein the energy is managed by the SoC and stored in an accumulator; and
an electrode positioned adjacent to the one or more indicators, wherein the SoC utilizes the electrode to sample information from the one or more indicators and transmit the information by the antenna.

2. The device of claim 1, wherein the antenna is made of at least one conductive pattern printed onto a thin flexible insulating substrate.

3. The device of claim 1, wherein the antenna is designed to receive and transmit radio-frequency (RF) signals in a short-range communication protocol.

4. The device of claim 3, wherein the antenna is adapted to receive RF signals in a plurality of RF bands for harvesting electromagnetic energy.

5. The device of claim 1, wherein the accumulator comprises one or more of an on-die capacitor, at least one external capacitor, and at least one rechargeable battery.

6. The device of claim 1, wherein the SoC comprises: a harvester; a controller; a transceiver; and a probe.

7. The device of claim 6, wherein the controller is partitioned into multiple power domains each comprising a set of gates powered by a common power supply, wherein only one power domain is turned on during execution.

8. The device of claim 6, wherein the controller is configured to manage power levels of the harvester and generate and prepare data packets for transmission.

9. The device of claim 6, wherein the controller utilizes the transceiver for communicating BLE protocols via the antenna.

10. The device of claim 6, wherein the harvester is configured to regulate and provide power into multiple DC voltage levels for operation of SoC and its subcomponents.

11. The device of claim 6, wherein the probe comprises circuitry configured to measure and digitize electrical properties sensed by the electrode.

12. The device of claim 11, wherein the electrical properties are at least one of the following: voltage; current; resistance; capacitance; induction; and light transparency.

13. The device of claim 1, wherein the electrode comprises one or more of a photovoltaic sensor, a dielectric sensor, an inductor, and a penetrating conductor.

14. The device of claim 1, wherein the electrode is attached to at least one indicator used for recording temperature or humidity over a predetermined time and displaying visual results.

15. The device of claim 1, wherein a controller compiles transmission representing temperature and/or humidity measurements over time and transmits the information to a server.
